(19) United States
(12) Patent Application Publication
(10) Pub. No.: US 2011/0204179 A1
(43) Pub. Date: Aug. 25, 2011

(54) ENGINE PYLON FOR AIRCRAFT

(75) Inventors: John Skelly, Mons (FR); Alexis Laporte, Toulouse (FR)

(73) Assignee: AIRBUS OPERATIONS (S.A.S.), Toulouse (FR)

(21) Appl. No.: 13/058,339

(22) PCT Filed: Aug. 7, 2009
(86) PCT No.: PCT/FR2009/000988

§ 371 Date: May 9, 2011

(30) Foreign Application Priority Data
Aug. 11, 2008 (FR) 08/04550

(51) Int. Cl. B64D 27/26; B64D 27/00; B23P 17/00

(52) U.S. Cl. 244/54; 29/401.1

(57) ABSTRACT

An engine pylon for an aircraft that includes a primary structure including aircraft mounting points arranged symmetrically relative to a middle vertical longitudinal plane of the pylon. The primary structure is asymmetrical relative to the middle vertical longitudinal plane and has respective fundamental modes of vibration in a vertical direction that are uncoupled from the fundamental modes of vibration thereof in a transverse direction.

The present invention relates to an engine pylon for aircraft.

In everything that follows, unless otherwise indicated, an engine pylon according to the invention or to the prior art is described in the position that it assumes when mounted in an aircraft and this aircraft is being observed in position on the ground, on a horizontal plane. The terms “vertical’, “horizontal”, “upper”, “lower”, etc. employed to describe parts or elements of the engine pylon, of the aircraft or of any other device are relative to this position. Furthermore, the term “transversal” refers to a direction known as transversal direction, substantially orthogonal to the longitudinal direction of the aircraft and substantially horizontal (when the aircraft is on the ground); in the case of an airplane, this transversal direction corresponds to the direction of the wing span of the airplane.

An engine pylon is a connecting device, by means of which an engine is attached to a wing or to the fuselage or to the tail of an aircraft. The engine pylon is fixed on the one hand to the engine casing and on the other hand to the primary structure of the wing, fuselage or tail of the aircraft, with the aid of fastening devices that may be more or less complex. An engine pylon usually comprises:
a primary structure adapted to transmit, to the aircraft structure, the forces and in particular the thrust generated by the engine; this primary structure generally forms a box comprising in particular longerons, crossbeams and vertical ribs; this box is symmetric relative to a median vertical longitudinal plane (plane containing the vertical and longitudinal directions and separating the box into two equal parts),
a secondary structure adapted to house, separate and if necessary support electrical cable ducts, hydraulic systems, fuel lines, etc. and to define air passages,
an aerodynamic fairing.

WO 03/074359 describes an engine pylon whose primary structure exhibits a width increasing toward the rear. Contrary to the usual practice, this pylon is provided, for its connection to the aircraft, with two rear fasteners disposed dissymmetrically relative to the vertical plane passing through the longitudinal axis of the engine. The primary structure of the pylon is also dissymmetric on the whole relative to this plane.

EP 1538080 provides another example of a turboprop pylon, whose primary structure is provided with a rear sub-wing box. In the usual manner, the primary structure of this pylon as well as its aircraft fasteners are symmetric relative to a vertical plane passing through the longitudinal axis of the turboprop. Such symmetry is desirable in terms of pick-up of the engine torque.

As explained in the foregoing, an engine pylon has in particular the function of transmitting, to the aircraft structure, the thrust forces generated by the engine. Unfortunately, the engine vibrations are also transmitted. In addition, the aircraft is exposed during flight to aerodynamic constraints, which may promote the engine vibrations or the phenomena that they induce, or directly cause other vibratory phenomena that are just as damaging. Thus all or part of the airframe on an aircraft may be affected by problems of:
flutter (vibratory instability): flutter of the aircraft wing group is caused by vibratory characteristics of the wing group and of engines suspended thereon; this flutter is the divergent coupling between the response of the wing group and of the engine and the aerodynamic forces induced by the movement; this vibratory instability between bending and torsional modes of the wing group and modes of the engine jeopardizes the integrity of the wing group and, under certain conditions, may culminate in its rupture,
buffeting (irregular oscillating accelerations along all the axes, resulting substantially from aerodynamic forces acting on the aircraft),
limited cyclic oscillations,
transonic buzz (aeroelastic vibrations of low amplitude),
aileron reversal,
longitudinal stability and controllability,
divergence.

A known method of limiting the flutter of the wing group of an aircraft is to limit the permitted maximum speed of the aircraft. Such a limitation is certainly not inherently satisfactory.

It is also known to use engine pylons and engine nacelles having, in the transversal direction, a natural vibration frequency confined to a very limited range, or else to equip the aircraft with a port engine pylon and a starboard engine pylon having different natural vibration frequencies in the transversal direction. These two solutions are sometimes insufficient. In addition, depending on the frequencies in question, they may lead to the design of relatively heavy engine pylons, and so they are not applied in practice, since mass is a critical factor in the field of aeronautics.

The invention is intended to provide an engine pylon that helps to alleviate, at least partly, the aforesaid problems—and especially the problems of flutter, buffeting and limited cyclic oscillations—and that additionally has a mass equivalent to or scarcely greater than that of the known engine pylons in use as well as aircraft fasteners arranged symmetrically relative to a median vertical longitudinal plane.

The invention is intended in particular to propose, for the problem of flutter, a solution that is more effective than the known prior solutions, without significant increase of mass.

Another objective of the invention is to provide an engine pylon of simple design.

Another objective of the invention is to make it possible to limit the aforesaid problems (and in particular the problems of flutter, buffeting and limited cyclic oscillations) by slightly modifying an existing pylon with which these problems may be encountered. One objective of the invention is to propose a modification that necessitates few calculations, is effected at lower cost and that leads to very little or no increase in the mass of the existing pylon. The invention therefore is intended to avoid the need for an entirely new design of an engine pylon for aircraft currently under or awaiting construction, when problems of flutter have been observed on an existing aircraft of the same model.

To achieve this, the invention relates to an engine pylon for aircraft comprising a primary structure provided with fastening points, referred to as aircraft fastening points, for connecting the pylon with a device that permits the said pylon to be joined to part of an airframe of an aircraft, the said aircraft fastening points being disposed symmetrically relative to a median vertical longitudinal plane of the pylon. The engine pylon according to the invention is characterized in that this primary structure is asymmetric relative to the median vertical longitudinal plane and its fundamental natural vibrational modes in a vertical direction are decoupled from its fundamental natural vibrational modes in a transversal direction.

In the present description, two natural modes are said to be “decoupled” when they have different shapes and/or different frequencies.

The invention is therefore based on two principles:
decoupling of the vertical and transversal fundamental natural modes of the primary structure of the engine pylon. The inventors have observed that such decoupling permitted a considerable reduction of the risks of flutter, buffeting and limited cyclic oscillations of an aircraft—and especially of the wing group thereof—equipped with such an engine pylon. This decoupling yields very satisfactory results in terms of attenuation of the vibrations induced by the engines in the aircraft structure. In the case of an aircraft with two or more engines, these results are valid whether the aircraft is equipped with port and starboard engines turning in the same direction or turning in opposite directions. Preferably, the first ten harmonics of the fundamental natural vibrational modes in the vertical direction and in the transversal direction of a primary pylon structure according to the invention are also all decoupled;
the asymmetric character of the primary structure of the engine pylon, whereas all known engine pylons whose aircraft fasteners are arranged symmetrically have primary structures that are symmetric relative to their median vertical longitudinal plane. The inventors have observed that this asymmetric character made it easier to design a primary structure that has both a mass equivalent to that of the known primary structures, and decoupled vertical and transversal fundamental natural modes (as well as the first ten harmonics thereof). In certain cases, this asymmetric character even proves to be the only solution for obtaining an engine pylon that satisfies the aforesaid two conditions as well as all the usual requirements in terms of mechanical strength.

Furthermore, starting from a known symmetric primary structure that exhibits a coupled vertical natural mode and transversal natural mode, or with which problems of flutter or other damaging vibratory phenomena have been observed, it is possible to achieve a primary structure that alleviates the problems simply by adequately reinforcing one side of the known primary structure to make it asymmetric and to decouple the natural modes that were causing problems. This modification is simple; it necessitates few calculations and it is not very costly to employ.

In this way the invention is extended to a method for modifying an engine pylon model for aircraft comprising a known symmetric primary structure, characterized in that one side of the said primary structure is reinforced so as to make it asymmetric relative to a median vertical longitudinal plane and so that its fundamental natural vibrational modes in the vertical direction are decoupled from its fundamental natural vibrational modes in the transversal direction.

Preferably, it is additionally verified that, by virtue of the added reinforcement, the first ten harmonics of the vertical and transversal fundamental natural modes of the modified primary structure are decoupled.

As explained in the foregoing, two decoupled natural modes have different shapes and/or frequencies. Advantageously, the difference between each fundamental natural frequency of the primary structure (of an engine pylon according to the invention) in the vertical direction and its closest fundamental natural frequency in the transversal direction is greater than 0.3 Hz in absolute value.

Advantageously, the primary structure of the engine pylon according to the invention exhibits a symmetric envelope shape relative to the median vertical longitudinal plane. By “envelope shape” there is understood the shape of a continuous (imaginary) surface enveloping the primary structure as closely as possible.

In the usual manner, the primary structure of the engine pylon according to the invention comprises aircraft fastening points—upper and lower—as defined in the foregoing (and in particular disposed symmetrically relative to the median vertical longitudinal plane), for connection thereof with a device known as aircraft fastening device. In addition, it comprises fastening points—generally lower—known as engine fastening points, for connection thereof with a device, known as engine fastening device, that permits the said engine pylon to be joined to the casing of an engine. Preferably, the primary structure of the engine pylon according to the invention comprises at least one upper aircraft fastening point known as left aircraft fastening point and one opposite upper aircraft fastening point known as right aircraft fastening point, the said left and right aircraft fastening points being spaced apart in the transversal direction (and being symmetric relative to the median longitudinal plane). It also comprises at least one lower engine fastening point known as left engine fastening point and one opposite lower engine fastening point known as right engine fastening point, the said left and right engine fastening points being spaced apart in the transversal direction. It should be noted that this primary structure may comprise a plurality of left aircraft—and respectively engine—fastening points and a plurality of right aircraft—and respectively engine—fastening points; the characteristics defined hereinafter for a pair of aircraft—and respectively engine—fastening points may be applied to other pairs of aircraft—and respectively engine—fastening points of the engine pylon. Furthermore, the primary structure of the engine pylon preferably comprises a lateral wall, referred to as left lateral wall, and an opposite lateral wall, referred to as right lateral wall.

Advantageously, the primary structure of the engine pylon according to the invention exhibits one or more of the following characteristics:
its interface stiffness at the left aircraft fastening point in the transversal direction is different from its interface stiffness at the right aircraft fastening point in the transversal direction; it should be noted that the expression “interface stiffness at a point in a direction” defines, in the usual way, the ratio between the variation of the force applied at that point in that direction and the displacement (variation of position) of the said point in the said direction (under the influence of this force);
its interface stiffness at the left engine fastening point in the transversal direction is different from its interface stiffness at the right engine fastening point in the transversal direction;
the stiffness of its left lateral wall in the transversal direction is different from the stiffness of its right lateral wall in the transversal direction;
its interface stiffness at the left aircraft fastening point in the vertical direction is different from its interface stiffness at the right aircraft fastening point in the vertical direction;
its interface stiffness at the left engine fastening point in the vertical direction is different from its interface stiffness at the right engine fastening point in the vertical direction;
the stiffness of its left lateral wall in the vertical direction is different from the stiffness of its right lateral wall in the vertical direction;
its left and right lateral walls comprise vertical stiffening ribs; to each vertical stiffening rib of the left lateral wall there corresponds a vertical stiffening rib of the right lateral wall, and vice versa; one of the said lateral walls (left or right) comprises one or more stiffening ribs that are reinforced compared with the corresponding stiffening ribs of the other wall;
one of its lateral walls (left or right) comprises one or more supplementary stiffening ribs compared with the other lateral wall;
the ratio between, on the one hand, its interface stiffness at the aircraft fastening points in the vertical direction and, on the other hand, its interface stiffness at the aircraft fastening points in the transversal direction is greater than a minimum threshold greater than 1 and preferably greater than or equal to 1.3; this minimum threshold may be a constant value or a function of one or more structural parameters, which may be chosen from among the interface stiffness of the primary structure of the engine pylon in the transversal direction at the aircraft fastening points, the interface stiffness of the aircraft fastening device in the vertical direction at the aircraft fastening points of the engine pylon, the stiffness of the structure of the wing group in the transversal direction; the stiffness of the structure of the wing group in the vertical direction; this function may be continuous or discontinuous, linear or nonlinear, etc.;
inversely, the ratio between, on the one hand, its interface stiffness at the aircraft fastening points in the vertical direction and, on the other hand, its interface stiffness at the aircraft fastening points in the transversal direction is smaller than a maximum threshold smaller than 1 and preferably smaller than or equal to 0.7;
this maximum threshold may be a constant value or a function of one or more structural parameters such as those cited in the preceding paragraph; this function may be continuous or discontinuous, linear or nonlinear, etc.;
the ratio between, on the one hand, its interface stiffness at the engine fastening points in the vertical direction and, on the other hand, its interface stiffness at the engine fastening points in the transversal direction is greater than a minimum threshold greater than 1 and preferably greater than or equal to 1.3; as explained in the foregoing, this minimum threshold may be a constant value or may depend on one or more structural parameters;
the ratio between, on the one hand, its interface stiffness at the engine fastening points in the vertical direction and, on the other hand, its interface stiffness at the engine fastening points in the transversal direction is smaller than a maximum threshold smaller than 1 and preferably smaller than or equal to 0.7; as explained in the foregoing, this maximum threshold may be a constant value or may depend on one or more structural parameters;

Possibly, as a variant or in combination, the asymmetric character defined in the foregoing between the interface stiffness at a left fastening point (aircraft or engine) in the vertical—or respectively transversal—direction and the interface stiffness at the opposite right fastening point (aircraft or engine) in the vertical—or respectively transversal—direction may be applied to interface damping coefficients. Similarly, as a variant or in combination, the fact that the ratio between the interface stiffness in the vertical direction at the aircraft—or respectively engine—fastening points and the interface stiffness in the transversal direction at the said aircraft—or respectively engine—fastening points is not close to 1 may be applied to interface damping coefficients. Nevertheless, the practical achievement of these characteristics leads to engine pylon structures that may be more complex when the damping coefficients are involved.

The present invention is extended to an aircraft comprising at least one engine pylon according to the invention.

It is extended in particular to an airplane comprising at least one engine pylon according to the invention on each of its two wings. It should be noted that the invention is applicable to a two-engine, three-engine, four-engine airplane, etc. Preferably, all the engine pylons of an aircraft, and especially of an airplane according to the invention are engine pylons according to the invention. These preferred embodiments do not exclude the possibility of providing an airplane (or in general an aircraft) that comprises only a single engine pylon according to the invention.

Advantageously, an aircraft according to the invention comprises engine pylons whose primary structures have fundamental natural vibrational modes in the vertical—or respectively transversal—direction that are decoupled from rigid modes and from flexible natural vibrational modes in the vertical—or respectively transversal—direction of the aircraft or of critical parts thereof, such as the wing group or the fuselage. Preferably, the fundamental natural (vertical and transversal) modes of each engine pylon, the longitudinal rigid modes of the aircraft (incidence, phugoid oscillation), the transversal (lateral) rigid modes of the aircraft (sideslip oscillation, roll) and their coupling (roll-yaw coupling, spiral, Dutch roll), the flexible natural modes of the wing group of an aircraft, and in particular of each of its wings if it is an airplane, and the flexible natural modes of the aircraft fuselage are all decoupled, meaning that they are all different from one another.

Other details and advantages of the present invention will become apparent upon reading the description hereinafter, which refers to the attached drawings and applies to a preferred embodiment, provided by way of non-limitative example. In these drawings:

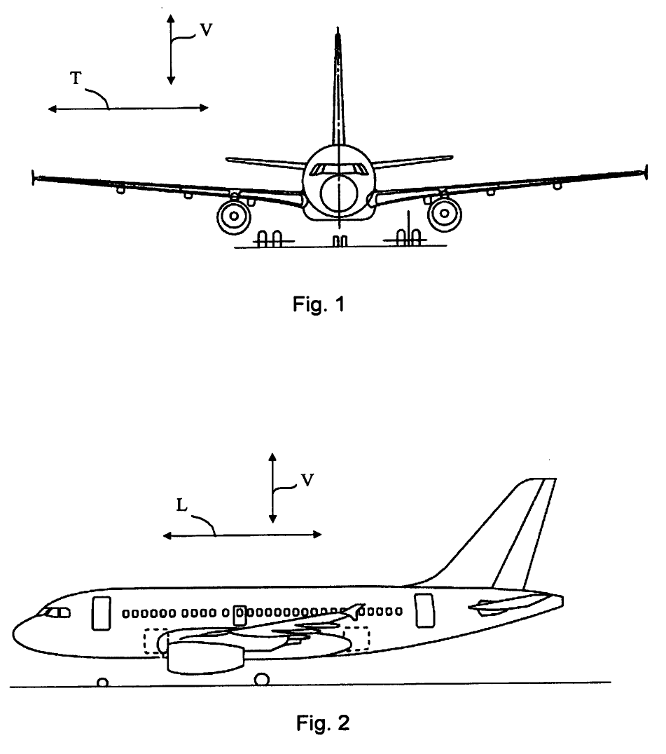

FIG. 1 is a front schematic view in elevation of an aircraft;

FIG. 2 is a schematic profile view in elevation of the aircraft of FIG. 1, and

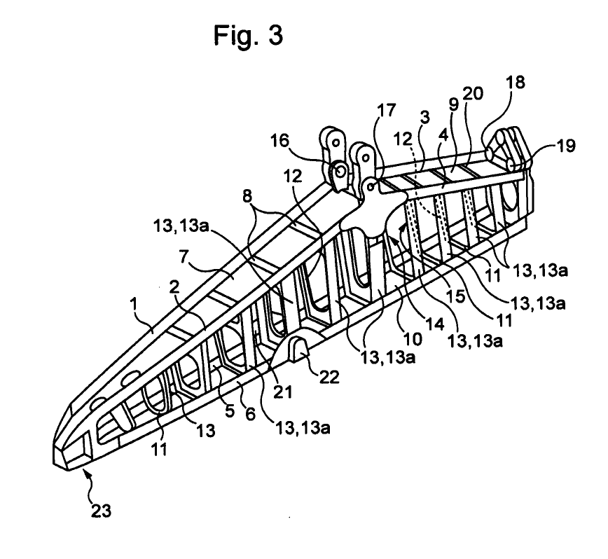

FIG. 3 is a schematic view in perspective of the primary structure of an engine pylon according to the invention, shown in the position that it assumes when the engine pylon is mounted in an aircraft such as that illustrated in FIGS. 1 and 2, observed in position on horizontal ground.

FIGS. 1 and 2 illustrate an aircraft in position on horizontal ground. In these figures, arrow L represents the longitudinal direction of the aircraft, arrow T represents its transversal direction (which corresponds to the direction of its wing span) and arrow V indicates the vertical direction (which corresponds to the direction of gravity when the airplane is in position on the ground).

The primary structure of the engine pylon illustrated in FIG. 3 comprises, in the usual way:
front upper longerons, including a right lateral longeron 1, a left lateral longeron 2 and possibly intermediate longerons (not shown),
rear upper longerons, including a right lateral longeron 3, a left lateral longeron 4 and possibly intermediate longerons (not shown),
lower longerons, which extend substantially in horizontal directions, including a right lateral longeron 5, a left lateral longeron 6 and possibly intermediate longerons (not shown),
if necessary, intermediate longerons (not shown) between lower longerons 5, 6 and upper longerons 1 to 4,
a front upper wall 7 extending between front upper longerons 1 and 2, which wall is reinforced by crossbeams 8 extending in a substantially transversal direction;
a rear upper wall 9 extending between rear upper longerons 3 and 4, which wall is reinforced by crossbeams 20 extending in a substantially transversal direction;
a lower wall 10 extending between lower longerons 5 and 6, which wall is reinforced by crossbeams 11 extending in a substantially transversal direction;
vertical ribs (which extend in a substantially vertical direction when the engine pylon is mounted in an aircraft), including right lateral ribs 12, which extend between right upper longerons 1, 3 and right lower longeron 5, and left lateral ribs 13, which extend between left upper longerons 2, 4 and left lower longeron 6. Right vertical ribs 12 define a right lateral wall 14, which may be open-worked (and, for example, composed solely of ribs 14) or solid (for reasons of clarity, such a solid wall is not shown in FIG. 3). Similarly, left vertical ribs 13 define a left lateral wall 15, which may be open-worked (and, for example, composed solely of ribs 13) or solid (for reasons of clarity, such a solid wall is not shown);
aircraft fastening points for connecting the engine pylon to an upper aircraft fastening device, which permits the said engine pylon to be joined to a part—such as a wing—of the airframe of an aircraft. These aircraft fastening points comprise in particular a right front upper fastening point 16 and a left front upper fastening point 17 spaced apart and facing one another in the transversal direction (these points are described as “front points”, because they are connected to a front part of the aircraft fastening device, but they extend in a relatively central zone of the engine pylon). These front aircraft fastening points are disposed symmetrically relative to a median longitudinal plane (plane that contains the longitudinal direction and the vertical direction and that separates the primary structure into two parts, left and right respectively, substantially of the same width). The aircraft fastening points also comprise a right rear upper fastening point 18 and a left rear upper fastening point 19, spaced apart and facing one another in the transversal direction. These rear aircraft fastening points (right and left) are themselves also disposed symmetrically relative to the median longitudinal plane. Finally, if necessary, the aircraft fastening points also comprise one or two rear lower fastening points (not visible in FIG. 3). It should be noted that the aircraft fastening device may comprise a plurality of independent parts or to the contrary may form a single all-in-one assembly;
engine fastening points for connecting the engine pylon to a lower engine fastening device, which permits the said engine pylon to be joined to the casing of an engine. These engine fastening points comprise in particular a right rear lower fastening point 21 and a left rear lower fastening point 22 spaced apart and facing one another in the transversal direction (these points are described as “rear points” because they are connected to a rear part of the engine fastening device, but they extend in a relatively central zone of the engine pylon). Preferably, these rear engine fastening points (right and left) are themselves also disposed symmetrically relative to the median longitudinal plane. In addition, the engine fastening points comprise a front lower fastening points 23. It should be noted that the engine fastening device may comprise a plurality of independent parts or to the contrary may form a single all-in-one assembly.

The primary structure of the illustrated engine pylon has a symmetric envelope shape relative to the median longitudinal plane. On the other hand, according to the invention, this primary structure is asymmetric relative to the median vertical longitudinal plane. In the illustrated example, among left vertical ribs 13, some, denoted by 13a, are reinforced compared with the corresponding right vertical ribs 12: each of these reinforced left ribs 13a has a cross section, and especially a width in the longitudinal direction and/or a thickness in the transversal direction that are larger than the cross section, the width and/or the thickness of the corresponding right rib, or in other words the right rib that extends opposite the said left rib in the transversal direction.

As a result, the illustrated primary structure possesses the following characteristics:
the stiffness of its right lateral wall 14 (which wall is formed at least partly by right vertical ribs 12) in the vertical direction is different from the stiffness of its left lateral wall 15 (which is formed at least partly by left vertical ribs 13) in the vertical direction;
its interface stiffness (local) at right aircraft fastening point 16 in the vertical direction is different from its interface stiffness (local) at left aircraft fastening point 17 in the vertical direction;
its interface stiffness (total) at right aircraft fastening points 16 and 18 in the vertical direction is different from its interface stiffness (total) at left aircraft fastening points 17 and 19 in the vertical direction;
its interface stiffness (local) at right engine fastening point 21 in the vertical direction is different from its interface stiffness (local) at left engine fastening point 22 in the vertical direction;
the stiffness of its right lateral wall 14 in the transversal direction is different from the stiffness of its left lateral wall 15 in the transversal direction;
its interface stiffness (local) at right aircraft fastening point 16 in the transversal direction is different from its interface stiffness (local) at left aircraft fastening point 17 in the transversal direction;
its interface stiffness (total) at right aircraft fastening points 16 and 18 in the transversal direction is different from its interface stiffness (total) at left aircraft fastening points 17 and 19 in the transversal direction;
its interface stiffness (local) at right engine fastening point 21 in the transversal direction is different from its interface stiffness (local) at left engine fastening point 22 in the transversal direction.

According to the invention, reinforced left ribs 13a are dimensioned so that the differences between the stiffnesses on the left (interface stiffnesses at the left—aircraft and engine—fastening points and stiffness of the left wall) and the stiffnesses on the right (interface stiffnesses at the right—aircraft and engine—fastening points and stiffness of the right wall) ensure that the fundamental natural vibrational modes of the engine pylon in the vertical direction and in the transversal direction are decoupled. Preferably, the first ten harmonics of the vertical and transversal fundamental natural modes of the primary structure of the engine pylon are decoupled.

More precisely, reinforced left ribs 13a are advantageously dimensioned such that the difference between each fundamental natural frequency in the vertical direction and the closest fundamental natural frequency in the transversal direction is greater than 0.3 Hz (in absolute value), or such that the difference between each fundamental natural frequency in the transversal direction and the closest fundamental natural frequency in the vertical direction is greater than 0.3 Hz (in absolute value).

The invention may be the object of numerous variants compared with the illustrated embodiment, provided these variants fall within the scope defined by the claims.

In particular, in the illustrated example, a series of successive left ribs 13 is composed of reinforced ribs 13a. The left ribs situated outside this series are not reinforced. It is possible to replace the latter by reinforced ribs. Conversely, it is also possible to distribute the reinforced ribs in different manner on the left side, for example by alternating reinforced ribs and “normal” ribs (all sequences are possible for this alternation).

Furthermore, in the illustrated example, left lateral wall 15 is reinforced relative to right lateral wall 14 by left ribs 13a (reinforced) having a larger cross section compared with the corresponding right ribs 12 situated facing them in transverse direction. Other modes of reinforcement are possible: for example, the left lateral wall may have a larger number of upper vertical ribs than that of the right lateral wall; as a variant or in combination, the right and left ribs may be made of materials of different stiffnesses; as a variant or in combination, left lateral wall 15 may comprise a rigid solid panel fixed to its ribs, while right lateral wall 14 remains open-worked; etc.

In addition, the illustrated structure possesses a lateral wall reinforced on the left side. Of course, as a variant, this reinforced wall (regardless of the mode of reinforcement used) may be provided on the right side.

In addition, an aircraft according to the invention may comprise, for example, a port engine pylon (or even two) and a starboard engine pylon (or even two), wherein the left—or respectively right—lateral walls are reinforced. As a variant, the aircraft may comprise a port engine pylon (or even two), wherein the left—or respectively right—lateral wall is reinforced, and a starboard engine pylon (or even two), wherein the right—or respectively left—lateral wall is reinforced.

1-12. (canceled)

13. An engine pylon for aircraft, comprising:
a primary structure including aircraft fastening points, for connecting the pylon with a device that permits the pylon to be joined to part of an airframe of an aircraft, the aircraft fastening points being disposed symmetrically relative to a median vertical longitudinal plane of the pylon,
wherein the primary structure is asymmetric relative to a median vertical longitudinal plane and its fundamental natural vibrational modes in a vertical direction are decoupled from its fundamental natural vibrational modes in a transversal direction.

14. An engine pylon according to claim 13, wherein first ten harmonics of the fundamental natural vibrational modes in the vertical direction and in the transversal direction of the primary structure are all decoupled.

15. An engine pylon according to claim 13, wherein a difference between each fundamental natural frequency of the primary structure in the vertical direction and its closest fundamental natural frequency in the transversal direction is greater than 0.3 Hz in absolute value.

16. An engine pylon according to claim 13, wherein the primary structure exhibits a symmetric envelope shape relative to the median vertical longitudinal plane.

17. An engine pylon according to claim 13, wherein the primary structure comprises at least one left upper aircraft fastening point and one right upper aircraft fastening point, spaced apart in the transversal direction, and interface stiffness of the primary structure at the left aircraft fastening point in the transversal or respectively vertical direction is different from interface stiffness of the primary structure at the right aircraft fastening point in the transversal or respectively vertical direction.

18. An engine pylon according to claim 13, wherein the primary structure comprises at least one left lower engine fastening point and one opposite right lower engine fastening point, spaced apart in the transversal direction, and interface stiffness of the primary structure at the left engine fastening point in the transversal or respectively vertical direction is different from interface stiffness of the primary structure at the right engine fastening point in the transversal or respectively vertical direction.

19. An engine pylon according to claim 13, wherein the primary structure comprises a left lateral wall and an opposite right lateral wall, and stiffness of the left lateral wall in the transversal or respectively vertical direction is different from stiffness of the right lateral wall in the transversal or respectively vertical direction.

20. An engine pylon according to claim 13, wherein the primary structure comprises a left lateral wall and an opposite right lateral wall, comprising corresponding vertical stiffening ribs, and one of the lateral walls comprises one or more vertical stiffening ribs that are reinforced compared with the corresponding vertical stiffening ribs of the other lateral wall.

21. An engine pylon according to claim 13, wherein the primary structure comprises a left lateral wall and an opposite right lateral wall, comprising vertical stiffening ribs, and one of the lateral walls comprises one or more supplementary vertical stiffening ribs compared with the other lateral wall.

22. An engine pylon according to claim 13, wherein the primary structure comprises aircraft fastening points and engine attachment points and a ratio between interface stiffness of the primary structure at the aircraft or respectively engine fastening points in the vertical direction and, interface stiffness of the primary structure at the aircraft or respectively engine fastening points in the transversal direction is either greater than a minimum threshold, which is greater than or equal to 1.3, or smaller than a maximum threshold, which is smaller than or equal to 0.7.

23. An aircraft, comprising at least one engine pylon according to claim 13.

24. A method for modifying an engine pylon model for aircraft including a symmetric primary structure, the method comprising:
reinforcing one side of the primary structure so as to make it asymmetric relative to a median vertical longitudinal plane and also so that its fundamental natural vibrational modes in a vertical direction are decoupled from its fundamental natural vibrational modes in a transversal direction.
